(19) United States
(12) Patent Application Publication
(10) Pub. No.: US 2006/0004727 A1
(43) Pub. Date: Jan. 5, 2006

(54) Text message system

(75) Inventors: Akseli Anttila, Helsinki (FI); Younghee Jung, Helsinki (FI); Harri Wikberg, Helsinki (FI)

Correspondence Address: HARRINGTON & SMITH, LLP, 4 RESEARCH DRIVE, SHELTON, CT, 06484-6212, US

(73) Assignee: Nokia Corporation

(21) Appl. No.: 11/165,668

(22) Filed: Jun. 24, 2005

(30) Foreign Application Priority Data
Jun. 30, 2004 (FI) 20040910

(51) Int. Cl. G06F 17/30

(52) U.S. Cl. 707/3

(57) ABSTRACT

A text message system in which a query-specific identifier is included in a text message requiring a reply. Replying takes place by accepting or rejecting options mentioned in the received query message, and the same query-specific identifier is automatically included in the reply message. When the reply message has arrived, a program in the terminal of the originator of the query updates a table based on the original message for the replier's part in accordance with the acceptance information in the reply. When the query message is sent to more than one recipient, all reply messages cause updating of the same table. The sender of the query messages can read the reply messages in the normal manner, and through the reply message or the original message he can also pass to reading the content of the table, or a summary of the replies. The information contained by the reply messages of the query is seen in compressed form in a specific table, and need not be collected manually. The information contained by the table is also always up to date, even if the group to which the query is directed were large and the query process continued in a plurality of steps.

The invention relates to a method for collecting information by text messages. The invention also relates to an arrangement for collecting information by text messages and a terminal device in which the arrangement is located.

### BACKGROUND OF THE INVENTION

The text message function commonly included in mobile stations enables simple communication between the parties either by messages which are separately notified or in chat form. A drawback of using ordinary text messages is the fact that when a message received is related to a former message, this relationship is not always directly appeared. In addition, the message received can be an inadequately formulated reply to an inquiry containing several options, in such way that the desired information is not reliably obtained from the reply. Such drawbacks are emphasized in a terminal device in which the message traffic is heavy. It would be helpful if the message automatically would refer to a certain former message when required. Naturally, such referring presumes suitable identifiers in the messages. True, the text messages include a message-specific identifier, but it is only used within the network to control the proceeding of the message. Such identifiers cannot be used for references between the messages or for creating other interaction taking place in the terminal device. In addition, communication of the question-and-answer type has the drawback that the content of the message has a free form, in which case the device does not recognize separate questions or answers from the text content. In communication between several people, the system has the drawback that it is not directly seen from the messages who are participating in the conversation, and how each participant has participated in the conversation.

In the Internet world, many addresses and identifiers of different levels are included in the heading of the messages to be transmitted. From there we know open text message systems are known, in which a person can join a user group. Messages can be sent to the group for reading, and they can be answered. An e-mail program in the user's own computer shows which messages are still unread. The system can group the messages on the basis of their subjects into message threads, which facilitates showing related messages to the user. However, such a system is not very suitable for a query-type communication situation, in which answers to questions are collected from a certain group of people. The system also requires a server connected to the network, which saves the messages in its register and also maintains it otherwise.

FIG. 1 is an exemplary flow chart showing how a known text message system is used for collecting information from a plurality of people. In the preliminary stage, the person implementing the query draws up the question(s) and decides on the target persons. In step 101, a text message containing the question is sent to selected persons' terminal device, in most cases a mobile phone. In step 102, reply messages come from the recipients of the query message. In step 103, the person carrying out the query reads reply messages and manually copies the essential information from them on paper or into a computer. In step 104 it is checked whether the information gathered is sufficient and corresponding to the current situation. If not, the steps 101 to 103 are repeated until the gathered information is satisfactory.

### SUMMARY OF THE INVENTION

The object of the invention is to reduce said prior art drawbacks by implementing an interactive text message system utilizing query-specific identifiers in terminal devices. The method according to the invention is characterized in what is set forth in the independent claim 1. The arrangement according to the invention is characterized in what is set forth in the independent claim 5, and the terminal device in what is set forth in the independent claim 8. Some preferred embodiments of the invention are set forth in the other claims.

The basic idea of the invention is the following: A query-specific identifier is included in a text message requiring a reply. Replying takes place by accepting or rejecting options mentioned in the received query message, and the same query-specific identifier is automatically included in the reply message. When the reply message has arrived, a program in the terminal of the originator of the query updates a table based on the original message for the replier's part in accordance with the acceptance information in the reply. When the query message is sent to more than one recipients, all reply messages cause the same table to be updated. The sender of the query messages can read the reply messages in the normal manner, and through the reply message or the original message he can also pass to reading the content of the table, or a summary of the replies.

An advantage of the invention is that the management of the information contained in the reply messages is improved as compared to the use of the known text message systems: Inadequate answers, at which it is uncertain what they are related to, do not occur, and the reply information need not be collected manually on paper or into a computer. Instead, the essential information is seen in compressed form in a specific table. The information in the table is also always up to date, even if the group to which the query is directed were large and the query process continued in a plurality of steps. In addition, the invention has the advantage that the system according to it can be implemented by relatively few additions to existing text message programs of mobile stations without a database in a separate server.

### BRIEF DESCRIPTION OF THE DRAWINGS

In the following, the invention will be described in more detail. Reference will be made to the accompanying drawings, in which

FIG. 1 presents an exemplary flow chart of a prior art method for collecting information by text messages,

FIG. 2 presents an exemplary flow chart of the method according to the invention for collecting information by text messages,

FIG. 3 presents the principle of the operation according to the invention as a time chart,

FIG. 4 presents one of the operations according to the invention as a sequence diagram

FIG. 5 presents an exemplary layer diagram of the arrangement according to the invention for the part of one terminal device, and

FIG. 6 presents an example of the terminal device according to the invention.

### DETAILED DESCRIPTION OF THE INVENTION

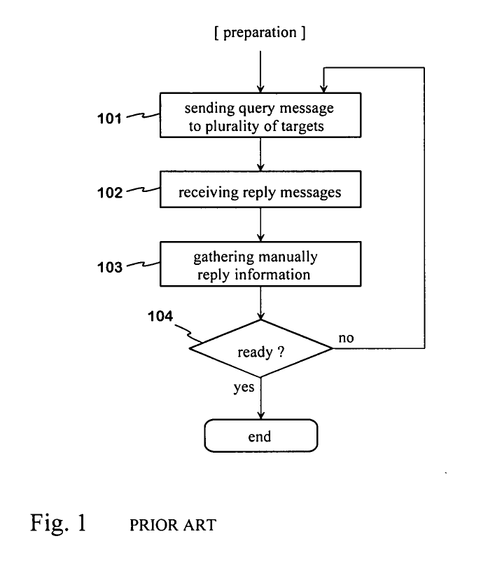

FIG. 1 was already explained in connection with the description of the prior art.

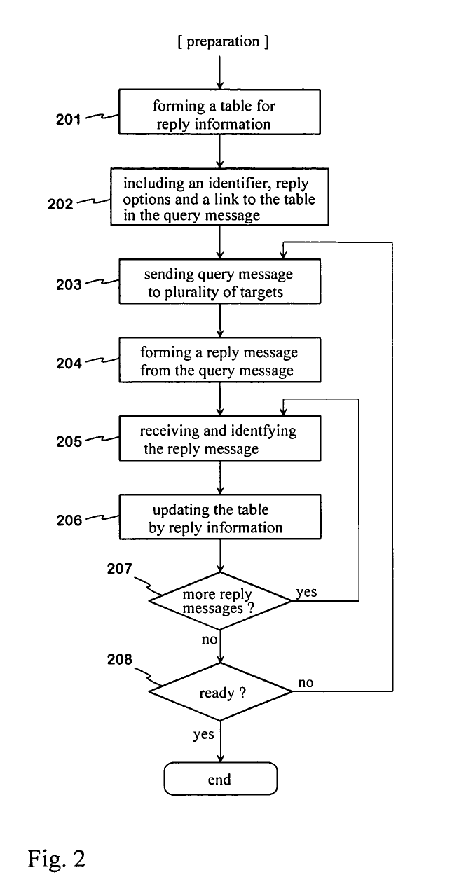

FIG. 2 is an exemplary flow chart of the method according to the invention for collecting information by text messages. In the preliminary stage, the question(s) and the reply options are drawn up, the target persons are decided and this information is given to the software of the text message system. The steps of the method only concern program functions in terminal devices, or terminals, participating in the process. In step 201 of the method, a table is formed for the information to be collected. The question-specific table is e.g. two-dimensional; one variable is the target person of the query and the other one is the reply option. In step 202, the original query message is formed. In this message is included an identifier, which is specific to the query, i.e. common to all the messages belonging to the information collecting process. In addition, in the original query message are included said reply options and a link to said table. Next, the query message is sent to the terminals of selected target persons, step 203. If a target person opens the received query message, he has a possibility to make selections from the options included therein. The person can accept one or more option or reject them all. Accepting takes place, for example, by taking the cursor on top of the option and by pressing the OK key. The person then need not write anything. The program prepares the reply message according to the selections (step 204). The reply message is similar to the query message with its identifier, only the reply information has been added. In step 205, the terminal program that sent the query message receives a reply message and finds the query-specific identifier in it. On the basis of this, the reply information in the reply message is transferred to the table at the name of the replier, step 206. Steps 205 and 206 are repeated according to step 207 always when a new reply message comes from a target person. Before step 208, the person carrying out the query checks whether the information gathered is sufficient and corresponding to the current situation. If not, the query message is possibly edited for re-transmission. In that case the program moves back to step 203.

The link to the table in the query message is also utilized when reading the reply information contained by the table. When the query message is opened, the program shows the link to the user e.g. as a text “See the summary” on the upper or lower edge of the message. When this link is selected by the cursor, the program brings to the display the table, from which the overall situation of the query can be seen at one glance. The same link is also seen when the reply message is opened. As an alternative, the program arranges the table as a part of the actual query message itself so that the table is seen at once when the message is opened.

The query-specific identifier can be a consecutive number, a number based on time, a random number or a number selected on some other basis. In addition to that, among other things, an identifier unique to the transmitting terminal, such as a telephone number, is included in the original message as the address of the reply messages. The identifiers are placed in the heading or some other part of the message. As an example, the original message could be like the following in XML (eXtensible Mark-up Language):

<message>
<identifier type=“original”>

<device_id type=“phone_number”>+3585551234</device_id>
<inquiry_id>2412200314250002</message_id>

</identifier>
<parameter type=“select”>

Select the meeting days suitable for you from the following:

<option>15.9.</option>
<option>21.9.</option>
<option>24.9.</option>

</parameter>
<message>

In addition to said identifiers, a question in the form of a request here and its reply options have been presented in it. In the example, the object of the option, or parameter, is the date of the planned meeting. The request sentence and the alternative dates are seen in the received and opened message. Let us assume that the replier selects the date 24.9. In that case, the description of the exemplary reply message is the following:

<message>
<identifier type=“reply”>

<device_id type=“phone_number”>deviceA</device_id>
<inquiry_id>2412200314250002</message_id>
<reply_device_id type=“phone_number”>deviceB</reply_device_id>

</identifier>
<parameter type=“select”>

Select the meeting days suitable for you from the following:

<option>15.9.</option>
<option>21.9.</option>
<option selected>24.9.</option>

</parameter>
</message>

It is seen from the description that the text message program of the replier's terminal also adds the telephone number of the replier's terminal (“device B”) to the reply message. As opened, the core part of the reply message is seen on the terminal of the originator of the query like the following, for example. The name of the replier is naturally found by the program from the normal list made by the user.
Active message:
original sent 2.7.2004
“Select the meeting days suitable for you from the following”
Pete selected the date 24.9.

If the originator of the query passes to check the overall situation by using the summary link, the view is like the following, for example:

| | 15.9. | 21.9. | 24.9. |
|---|---|---|---|
| Aksu | x | o | x |
| Vesa | x | x | o |
| Tuuli | o | o | o |
| Pete | o | o | x |
| Harri | — | — | — |
| . | | | |
| . | | | |
| . | | | |

Of the other repliers of the example, The dates 15 September and 24 September suit Aksu, and the dates 15 September and 21 September suit Vesa. None of the dates offered suit for Tuuli, and Harri has not answered yet.

The table can also be one-dimensional, containing only the reply option as a variable. In that case, the table is updated so that an acceptance mark in the reply message increases the number of votes for the option in question. In this case, the summary view is like the following:

| | 15.9. | 21.9. | 24.9. |
|---|---|---|---|
| votes | 7 | 2 | 5 |

The summary could also be shown more simply so that the program only notifies of the option that received the largest number of votes and the number of votes it received. The program can include, as an extension, a result monitoring part, which automatically sends a notification of the end of the query to the participants, if, for example, the number of votes of an option has reached a predetermined limit. It is also possible to set an automatic time limit for taking the replies into consideration.

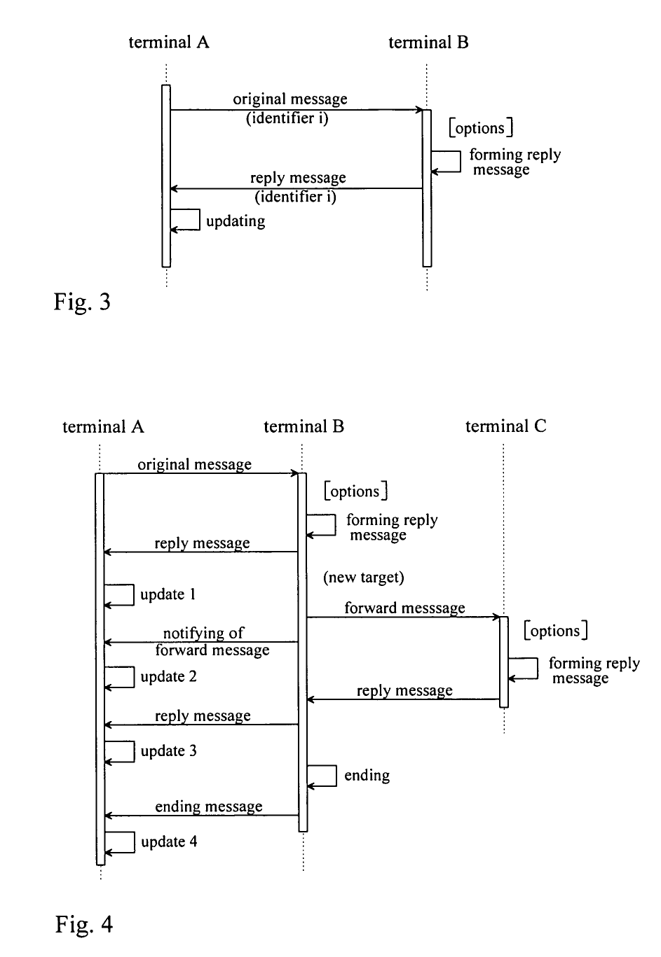

FIG. 3 shows a simple sequence diagram of the principle of the operation according to the invention. The originator of the query uses terminal A and a selected target of the query uses terminal B. The original query message addressed to terminal B and containing a query-specific identifier i leaves from terminal A. The user of terminal B opens the message received and makes selections in it required by the subject matter proper of the message. After this, terminal B forms a reply message and sends the identifier to terminal A. Terminal A finds the identifier i in the reply message and updates the content of the table referred to by the identifier by the reply information found in the reply message.

FIG. 4 shows an exemplary sequence diagram of a functionality according to the invention, in which a person being a target of the query extends the query to a new person. The originator of the query uses terminal A and a selected target of the query uses terminal B. The original query message addressed to terminal B and containing a query-specific identifier leaves terminal A. This identifier is also included in all the following messages. The user of terminal B opens the message received and makes selections in it required by the subject matter proper of the message. After this, terminal B forms a reply message and sends it to terminal A. Terminal A finds a query-specific identifier in the reply message and updates the content of the table referred to by the identifier by the reply information found in the reply message. In the diagram, this function is marked as “update 1”. In this example, the user of terminal B has a suitable new target person in mind to be joined to the query. He/she opens again the original message received and addresses it to the new target person. Terminal B sends the message as an unchanged forward message to new target person's terminal C. In addition, terminal B automatically sends a notification of the forward message to terminal A. This notification message includes information of the new target person, on the basis of which terminal A adds a new name to the table referred to by the query-specific identifier. In the diagram, this function is marked as “update 2”. The user of terminal C opens the message received and makes selections in it required by the subject matter proper of the message. After this, terminal C forms a reply message and sends it to terminal B. Terminal B finds a query-specific identifier in the reply message and forwards the message automatically to terminal A. Alternatively, the user of terminal B, after opening a reply message from terminal C, manually starts the forward sending. Terminal A finds a query-specific identifier in this second reply message again and updates the content of the table referred to by the identifier by the reply information found in the reply message. In the chart, this function is marked as “update 3”. Terminal B sends an ending message more to terminal A to notify it that no more reply messages are coming. Terminal A updates the status information of the process on the basis of the ending message. In the chart, this function is marked as “update 4”.

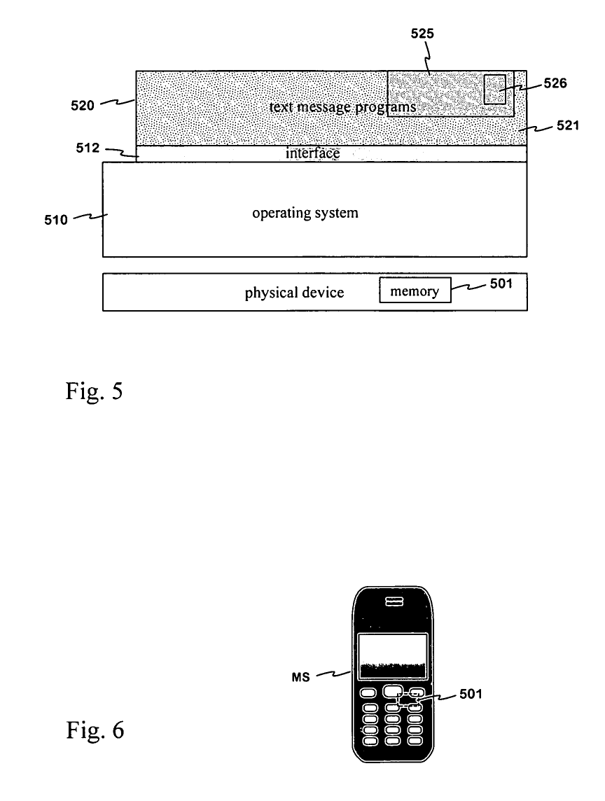

FIG. 5 shows an exemplary layer diagram of the arrangement according to the invention for the part of one terminal device. As a “bottom layer” in the figure is the physical part of the terminal device containing the arrangement. The physical part includes, among other things, the memory 501 of the device, in which the software of the device has been stored. Of the software, the operating system 510 of the device, an interface 512 and the text message programs 520 are seen in the figure. The interface is an adaptator program, through which the text message programs use the operating system services. The text message programs are divided into a known part 521 and parts 525, 526 according to the invention. Of the last mentioned, part 525 is function code and part 526 includes the messages formed during the information collecting process and a table in which query-specific information is stored in a centralized manner. The function code includes a program which implements the storing by updating the table by the reply information being located in the received messages. In addition, the function code has a portion which brings the table to the display of the device when a message belonging to the information collecting process is opened. Furthermore, the function code includes, among other things, a number generator for including in the query message to be sent a query-specific identifier, and an identifying part noticing detector for detecting a query-specific identifier in a received message.

FIG. 6 shows an example of a terminal device, which has an arrangement according to the invention. The terminal device MS has a memory 501 mentioned in the description of FIG. 5, which again includes the software according to the invention.

A method and arrangement for collecting information by text messages has been described above. The invention is not limited to the matters just explained. For example, the text message containing a question or an answer can be the text part of a multimedia message instead of an ordinary text message. The invention can be applied in different ways within the limits set by the independent claims 1, 5 and 8.

1. A method for collecting information by text messages, in which method an original text message requiring an answer is sent from a basic terminal to at least one target terminal, reply messages are received from the target terminals and desired information is separated from the reply messages, the method further comprising steps;
forming a table is formed, in which at least reply option to the question drawn up by an originator of query is a variable
choosing a query-specific identifier for the process of collecting said information
including in the original message a link to said table, said identifier and the reply options of at least one question
forming a reply message of the original message received in the target terminal by marking reply options in it as accepted or rejected according to the selection made by a user of the terminal
in the basic terminal, founding the reply message as belonging to said collecting process on the basis of the identifier in the reply message
carrying out said separating of the desired information from the reply message by updating content of said table by information about the acceptance of options in the reply message
when required, again sending a query message similar to the original text message with at least one changed reply option to the target terminals, and repeating the updating of the table by the information of the reply messages.

2. A method according to claim 1, the content of said table being brought to a display of a terminal device when a user activates said link.

3. A method according to claim 1, a notification of the end of the query being sent to the participants of the query if the number of votes for one of the options has reached a predetermined limit.

4. A method according to claim 1, further comprising steps;
forwarding the original message from a target terminal to a third terminal, and
receiving the reply message from the third terminal in the target terminal and forwarding it to the basic terminal.

5. An arrangement in a terminal device for collecting information by text messages, which arrangement comprises means for sending and receiving text mes-sages, which text messages are query messages and their reply messages in an information collecting process, the arrangement further comprising;
a query-specific table to store said information in a centralized manner
a number generator to include in the query message to be sent a query-specific identifier
an identifying part to notice the query-specific identifier in a received message
means to update said table by reply information found in the received message, and
means to present the table on a display of the terminal device when a message belonging to said collecting process is open.

6. An arrangement according to claim 5, said table being two-dimensional so that one of the variables is target person of the query and the other one is reply option of the query.

7. An arrangement according to claim 5, said table being one-dimensional so that only reply option of the query is a variable.

8. A terminal device, which comprises means for sending and receiving text messages in an information collecting process, which text messages are query messages and their reply messages, the terminal device further comprising;
a query-specific table to store said information in a centralized manner
a number generator to include in the query message to be sent with a query-specific identifier
an identifying part to notice the query-specific identifier in a received message
means to update said table by reply information found in the received message, and
means to present the table on a display of the terminal device when a message belonging to said collecting process is open.

9. A terminal device according to claim 8, being a mobile station.
